(19) United States
(12) Patent Application Publication
(10) Pub. No.: US 2026/0027914 A1
(43) Pub. Date: Jan. 29, 2026

(54) PROTECTIVE ELEMENT, METHOD FOR PRODUCTION THEREOF, ENERGY STORAGE SYSTEM AND MOTOR VEHICLE

(71) Applicant: ElringKlinger AG, Dettingen (DE)

(72) Inventor: Bernd TRABER, Dettingen (DE)

(73) Assignee: ElringKlinger AG, Dettingen (DE)

(21) Appl. No.: 19/346,235

(22) Filed: Sep. 30, 2025

Related U.S. Application Data
(63) Continuation of application No. PCT/EP2024/062206, filed on May 3, 2024.

(30) Foreign Application Priority Data
May 5, 2023 (DE) 10 2023 111 776.9

(51) Int. Cl. B60L 50/64; B60L 50/60; H01M 50/218; H01M 50/24

(52) U.S. Cl. CPC B60L 50/64; B60L 50/66; H01M 50/218; H01M 50/24

(57) ABSTRACT

A protective element, in particular for an energy storage system or for a motor vehicle, wherein the protective element has the following: a shielding element, for example a wall, and a protective material arranged or formed on a surface of the shielding element.

### RELATED APPLICATION

This application is a continuation of international application No. PCT/EP2024/062206 filed May 3, 2024 and claims the benefit of German application No. 10 2023 111 776.9 filed on May 5, 2023, which are incorporated herein by reference in their entirety and for all purposes.

### FIELD OF DISCLOSURE

The present invention relates to the technical field of shielding against hazards which may arise in connection with energy storage systems of electrically driven motor vehicles in the event of serious traffic accidents.

On the one hand, it concerns shielding against hazards which may arise for energy storage systems of electrically driven motor vehicles in the event of serious traffic accidents. On the other hand, it concerns shielding against hazards which may originate from such energy storage systems in the event of serious traffic accidents.

### BACKGROUND

Energy storage cells, for example electrochemical energy storage cells, are installed in wholly or partially electrically driven motor vehicles. In particular in the event of serious accidents, extreme applied forces can lead to a thermal runaway of energy storage cells. Hot fluids can here be released in an explosive manner. They are loaded with particles having an abrasive action. It is known that the hot fluid streams can damage or even penetrate surrounding materials, for example walls of energy storage systems.

Consequently, it is necessary to reduce the risk of extreme applied forces on energy storage cells and—if a thermal runaway occurs—to prevent as far as possible any consequential damage which may arise as a result of a thermal runaway.

### SUMMARY OF THE INVENTION

The present invention is based on the object of providing a motor vehicle, an energy storage system and a protective element that are obtainable with a low outlay and offer efficient protection. They are in particular to efficiently counteract damage caused by and consequential damage of external applied forces and accidents. Advantageously, they are to make it possible to increase the range of a motor vehicle.

The object is achieved according to the invention by the protective element as claimed in the relevant independent claim.

The protective element can be in particular a protective element for an energy storage system or for a motor vehicle.

The expression “in particular” is used within the context of this description and the appended claims preferably to describe optional features.

Preferably, the protective element can be a protective element for an energy storage system.

The energy storage system can be in particular an electrochemical energy storage system.

At least part of the electrical energy that can be stored by the energy storage system can be taken up and delivered by chemical reactions, which can take place at at least one anode and at least one cathode.

Preferably, the protective element can be a protective element for a motor vehicle.

The energy storage system can be, for example, an energy storage system for driving a motor vehicle.

The protective element can have in particular the following:
a shielding element, and
a protective material arranged or formed on a surface of the shielding element.

There is suitable as the shielding element in particular any wall element or component that has at least one surface on which the protective material can be arranged or formed. In particular, at least a low protective effect for the energy storage system or for the motor vehicle is to be achievable with the shielding element.

The shielding element can, for example, be a wall or have a wall.

The shielding element, for example the wall, can preferably comprise a flat material, be formed of a flat material or consist of the flat material.

It can be expedient for the flat material to comprise a flat base body, which can be provided with at least one surface structure. The at least one surface structure can be selected, for example, from beads, depressions or elevations.

The flat material is accordingly not necessarily completely planar but instead is simply particularly large in two dimensions compared to a third dimension, which forms the thickness direction.

The at least one surface structure has been found to be advantageous for counteracting or compensating for thermally induced deformation, which can occur on heating of the shielding element. This is the case in particular if the flat material is heated very quickly at one point, for example as a result of a thermal runaway.

The at least one surface structure can function as a stiffening element, in particular with respect to thermally induced deformation, which can be promoted in particular by a thermal runaway of an energy storage cell.

It can be preferred for the at least one surface structure to yield a regular pattern or to yield part of a pattern formed of the at least one surface structure and a further surface structure.

This can be particularly advantageous. This is because zones of the regular pattern that are repeated in the surface can each be allocated to individual energy storage cells and arranged at those cells and can thus prevent thermally induced deformation equally in many or all regions of the shielding element, substantially independently of where a thermal runaway occurs in an energy storage cell.

The flat material can have two main surfaces.

The surface of the shielding element can be one of the two main surfaces and the protective material can be arranged or formed on the main surface. An adhesive layer described herein, for example, can optionally be arranged therebetween.

The shielding element can comprise a composite material or be formed of a composite material.

Advantageously, the composite material can be a fiber-reinforced composite material.

Advantageously, the composite material can be a laminated composite material.

The flat material can comprise the composite material or consist of the composite material.

Alternatively or in addition, it can be provided that the flat material comprises one or more metallic materials or is formed of one or more metallic materials. For example, one or more metal plies, in particular metal foils, metal sheets, etc., can be provided.

Preferably, the protective material can be arranged or formed on the surface by thermal spraying.

The methods of thermal spraying are generally known surface-coating methods. Addition materials, which are also referred to as spraying additives, are melted, partially melted or superficially melted inside or outside a spray burner, accelerated in a gas stream in the form of spray particles, and projected onto the surface of the shielding element. In most cases, the surface is not partially melted and is thermally loaded to only a small extent. Formation of the protective material can take place in particular as lamination, since the spray particles can flatten to a greater or lesser extent on impact with the component surface depending on the process and the material, primarily can stick by mechanical interlocking and can build up protective material ply by ply, for example.

Characteristic features of the protective material arranged or formed on the surface by thermal spraying are low porosity, good bonding to the shielding element, as far as possible the absence of cracks, and a homogeneous microstructure.

The energy sources used for partially or superficially melting the spray additive are, for example, an electric arc (so-called “electric arc spraying”), a plasma jet (so-called “plasma spraying”), a fuel-oxygen flame (so-called “flame spraying”), a high-velocity fuel-oxygen flame (so-called “high-velocity flame spraying”), rapid preheated gases (so-called “cold spraying”) or a laser beam (so-called “laser beam spraying”).

Systems and apparatuses for thermal spraying are generally known to those skilled in the art.

Systems and apparatuses for thermal spraying are, for example, also described in German utility model no. 1 932 150 and in document DE 689 14 074 T2. German utility model no. 1 932 150 describes an apparatus for thermal spraying in the form of a plasma spray gun. Document DE 689 14 074 T2 describes a high-velocity flame spraying apparatus.

Preferably, the protective material can be arranged or formed on the surface by plasma spraying, by flame spraying, by high-velocity flame spraying, by electric arc spraying, by cold spraying or by laser beam spraying.

Particularly preferably, the protective material can be arranged or formed on the surface by plasma spraying, by flame spraying or by high-velocity flame spraying.

It can be preferred for the protective material to increase the hot-fluid resistance of the shielding element; and/or to increase the media resistance of the shielding element; and/or to increase the corrosion resistance of the shielding element; and/or to impede an electrical breakdown to the shielding element; and/or to increase the impact resistance of the shielding element.

The protective material can, for example, increase the hot-fluid resistance of the shielding element.

The protective material can, for example, increase the media resistance of the shielding element.

The protective material can, for example, increase the corrosion resistance of the shielding element.

The protective material can, for example, impede an electrical breakdown to the shielding element.

The protective material can, for example, increase the impact resistance of the shielding element.

If the protective material increases the hot-fluid resistance of the shielding element, this can mean, for example, that the resistance of the shielding element to a hot fluid that can be released in the event of a thermal runaway of an electrochemical energy storage cell is higher with the protective material than without the protective material.

If the protective material increases the media resistance of the shielding element, this can mean, for example, that the media resistance of the shielding element with respect to a medium that can be conveyed at the surface is higher with the protective material than without the protective material. The medium can preferably be a temperature-control medium, for example a temperature-control fluid. The media resistance can preferably be resistance to temperature-control media, for example resistance to a temperature-control fluid.

If the protective material increases the corrosion resistance of the shielding element, this can mean, for example, that the corrosion resistance of the shielding element with respect to a surrounding fluid, for example air, is higher than without the protective material.

If the protective material impedes an electrical breakdown to the shielding element, this can mean, for example, that an electrical breakdown through the protective material to the shielding element takes place only at a higher voltage than without the protective material.

If the protective material increases the impact resistance of the shielding element, this can mean, for example, that damage resulting from the impact of a body on the shielding element provided with the protective material is lower than damage resulting from the impact of a body on a shielding element without protective material under the same test conditions.

By increasing the corrosion resistance, an action of the shielding element as underbody protection can be increased.

The same applies to an increase in the impact resistance. It is hereby possible in particular to effectively counteract in protection against the penetration of foreign bodies through an underbody of a motor vehicle.

It can be particularly advantageous for the protective material to comprise at least one high-temperature-stable alloy according to formula (I)

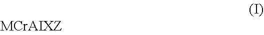

wherein
M represents at least one of the chemical elements Ni, Co, Fe,
X represents at least one optional chemical element selected from Y, Si and/or Ti,
Z represents at least one optional further chemical element.

The chemical elements that can be represented by X and Z are optional.

If only the chemical element X or only chemical elements X are present and chemical elements Z are absent, formula (I) can read MCrAlX.

If only the chemical element Z or only chemical elements Z are present and chemical elements X are absent, formula (I) can thus read MCrAlZ.

If chemical elements X and Z are absent, formula (I) can read MCrAl.

M can preferably represent at least one of the chemical elements Ni or Co. It can be particularly preferred for M to represent the chemical element Ni.

X can preferably represent the chemical element Y.

Z can preferably comprise at least one of the chemical elements Ta, Mo, W, C, B, Zr, Nb, Hf.

A mass fraction of the chemical element Cr can advantageously be from 2 to 55 wt. %, preferably from 4 to 45 wt. %, particularly preferably from 6 to 40 wt. %, for example from 10 to 30 wt. %.

A mass fraction of the chemical element Al can advantageously be from 1 to 35 wt. %, preferably from 1.5 to 28 wt. %, particularly preferably from 1.5 to 18 wt. %, for example from 2 to 10 wt. %.

A mass fraction of the optional chemical element represented by X or of the optional chemical elements represented by X can advantageously be up to 5 wt. %, preferably from 0.01 to 4 wt. %, particularly preferably from 0.02 to 3 wt. %, for example from 0.03 to 3 wt. %. If X represents more than one of the chemical elements Y, Si, Ti, the multiple chemical elements represented by X are included in the calculation of the mass fraction.

A mass fraction of the chemical element represented by Z or of the chemical elements represented by Z can advantageously be up to 18 wt. %, preferably from 0.001 to 18 wt. %, particularly preferably from 0.02 to 15 wt. %. If Z represents more than one chemical element, the multiple chemical elements represented by Z are included in the calculation of the mass fraction.

A mass fraction of the chemical element represented by M or of the chemical elements represented by M can advantageously be from 8 to 97 wt. %, preferably from 20 to 95 wt. %, particularly preferably from 45 to 93 wt. %. If M represents more than one chemical element, the multiple chemical elements represented by M are included in the calculation of the mass fraction.

The protective material can comprise a protective layer or can be a protective layer.

The protective material can comprise a protective layer formed of the at least one high-temperature-stable alloy according to formula (I) or can be a protective layer formed of the at least one high-temperature-stable alloy according to formula (I).

It can be particularly advantageous for the protective material to comprise a NiCrAlY alloy (e.g. a NiCrAlY alloy according to formula (I)), a cobalt-based alloy, a FeCrAl alloy (e.g. a FeCrAl alloy according to formula (I)), a nickel-based superalloy, a cobalt-based superalloy, tungsten, tungsten-chromium, tantalum, molybdenum, niobium, a titanium aluminide, a ceramic, aluminum oxide, zirconium oxide, titanium oxide, magnesium oxide, chromium oxide, yttrium oxide, tungsten carbide, a tungsten carbide-cobalt alloy, for example WC—Co 12, silicon carbide, silicon nitride, titanium carbide, tantalum carbide and/or hafnium carbide.

The protective material can comprise a thermal insulation layer.

The thermal insulation layer can be a so-called thermal barrier coating (TBC).

The thermal insulation layer can preferably be a coating ceramic. The coating ceramic can comprise an aluminum oxide and/or a zirconium oxide.

It is known that thermal insulation layers are used in industry in order to lower the material temperature in high-temperature applications. An example are new and retrofitted gas turbines, in which the coating is applied according to requirements in the range of from a few tenths of a millimeter to millimeters to the blades and to other components in the so-called hot-air path of turbines, such as heat shields and combustion chamber segments. Turbine blade materials can thus be used at exhaust gas temperatures of over 1400° C., because the temperature of the material can be lowered by means of a thermal insulation layer to below 1100° C., at which the material still possesses sufficiently high strength.

Such thermal insulation layers are also suitable as the protective material in connection with the invention.

The protective material can be bonded to the surface of the shielding element by way of an adhesive layer, for example by way of a bond coat likewise known from the field of turbine coating.

The adhesive layer can comprise nickel, cobalt, aluminum, molybdenum and/or yttrium. The thickness of the adhesive layer can be, for example, from 0.05 to 0.3 mm.

The protective material can comprise a protective layer formed of at least one of the materials listed here or can be a protective layer formed of at least one of the materials listed here.

It can be preferred for the protective material to increase the hot-fluid resistance of the shielding element and for the protective material to comprise a NiCrAlY alloy (e.g. a NiCrAlY alloy according to formula (I)), a cobalt-based alloy, a FeCrAl alloy (e.g. a FeCrAl alloy according to formula (I)), a nickel-based superalloy, a cobalt-based superalloy, tungsten, tungsten-chromium, tantalum, molybdenum, niobium, a titanium aluminide, a ceramic, aluminum oxide, zirconium oxide, titanium oxide, magnesium oxide, chromium oxide, yttrium oxide, tungsten carbide, a tungsten carbide-cobalt alloy, for example WC—Co 12, silicon carbide, silicon nitride, titanium carbide, tantalum carbide and/or hafnium carbide.

It can be preferred for the protective material to increase the media resistance of the shielding element and/or to increase the corrosion resistance of the shielding element and for the protective material to comprise a NiCrAlY alloy (e.g. a NiCrAlY alloy according to formula (I)), a cobalt-based alloy, a FeCrAl alloy (e.g. a FeCrAl alloy according to formula (I)), a nickel-based superalloy, a cobalt-based superalloy, tungsten, tungsten-chromium, tantalum, molybdenum, niobium, a titanium aluminide, a ceramic, aluminum oxide, zirconium oxide, titanium oxide, magnesium oxide, chromium oxide, yttrium oxide, tungsten carbide, a tungsten carbide-cobalt alloy, for example WC—Co 12, silicon carbide, silicon nitride, titanium carbide, tantalum carbide and/or hafnium carbide.

It can be preferred for the protective material to impede an electrical breakdown to the shielding element and for the protective material to comprise a titanium aluminide, a ceramic, aluminum oxide, zirconium oxide, titanium oxide, magnesium oxide, chromium oxide, yttrium oxide, tungsten carbide, a tungsten carbide-cobalt alloy, for example WC—Co 12, silicon carbide, silicon nitride, titanium carbide, tantalum carbide and/or hafnium carbide.

It can be preferred for the protective material to increase the impact resistance of the shielding element and for the protective material to comprise a NiCrAlY alloy (e.g. a NiCrAlY alloy according to formula (I)), a cobalt-based alloy, a FeCrAl alloy (e.g. a FeCrAl alloy according to formula (I)), a nickel-based superalloy, a cobalt-based superalloy, tungsten, tungsten-chromium, tantalum, molybdenum, niobium, a titanium aluminide, a ceramic, aluminum oxide, zirconium oxide, titanium oxide, magnesium oxide, chromium oxide, yttrium oxide, tungsten carbide, a tungsten carbide-cobalt alloy, for example WC—Co 12, silicon carbide, silicon nitride, titanium carbide, tantalum carbide and/or hafnium carbide.

It can be very particularly advantageous for the protective material to comprise a NiCrAlY alloy. The NiCrAlY alloy can be, for example, a NiCrAlY alloy according to formula (I). The protective material can comprise a protective layer formed of the NiCrAlY alloy or can be a protective layer formed of the NiCrAlY alloy.

NiCrAlY alloys are generally known. On account of their high temperature resistance and corrosion resistance, they are frequently used in the aviation and energy industries. They are frequently used in the manufacture of components that are exposed to high temperatures, such as, for example, turbine blades, combustion chambers and nozzles. At high temperatures, the alloys can form a stable oxide layer, which protects the underlying material from corrosion and at the same time can increase the mechanical strength of the alloy.

Specific alloys according to formula (I), in particular examples of NiCrAlY alloys, are described in document WO 03/060194 A1 and in U.S. Pat. No. 4,477,538.

NiCrAlY alloys can comprise, for example:
71 wt. % nickel, 19 wt. % chromium, 9 wt. % aluminum and 1 wt. % yttrium;
73 wt. % nickel, 16 wt. % chromium, 8 wt. % aluminum and 3 wt. % yttrium; or
70 wt. % nickel, 22 wt. % chromium, 5 wt. % aluminum, 1 wt. % yttrium and 2 wt. % hafnium.

The protective material can have pores. The pores can be filled or closed wholly or partially with a pore-filling material.

The pore-filling material can be, for example, a carbon material, can be a precursor of a carbon material, can comprise a carbon material or can comprise a precursor of a carbon material.

The precursor of the carbon material can be selected from carbonizable materials, preferably resins, for example phenolic resins.

The object is achieved according to the invention by the energy storage system as claimed in the relevant independent claim.

The energy storage system has already been described in detail in connection with the protective element according to the invention. The energy storage system according to the invention can be in particular an electrochemical energy storage system.

The energy storage system can be, for example, an energy storage system for driving a motor vehicle.

The energy storage system can comprise in particular the following:
a protective element, described herein, according to the invention, and
an energy storage cell, for example an electrochemical energy storage cell,
   wherein a surface of the shielding element on which the protective material is arranged or formed faces the energy storage cell.

At least part of the electrical energy that can be stored by the energy storage system can be taken up and delivered by chemical reactions, which can take place at at least one anode and at least one cathode of the at least one electrochemical energy storage cell.

Advantageously, the energy storage system can comprise the following:
a protective element, described herein, according to the invention, and
multiple energy storage cells, for example multiple electrochemical energy storage cells,
   wherein a surface of the shielding element on which the protective material is arranged or formed faces a plurality of the multiple energy storage cells.

The protective element comprised by the energy storage system can form part of a housing or of an enclosure of the energy storage system.

The shielding element can be a wall of the housing or of the enclosure. The wall can form a floor, a side wall or a cover, preferably a cover, of the housing or of the enclosure.

The protective material can preferably be arranged or formed on a surface of the wall that faces the energy storage cell or the plurality of energy storage cells.

Preferably, the surface that faces the energy storage cell can face a rupture zone formed on the energy storage cell.

Preferably, the surface that faces the plurality of energy storage cells can face a plurality of rupture zones formed on the energy storage cells.

A rupture zone can be in particular a zone at which a cell casing of an energy storage cell has a predetermined breaking point. If a growing pressure builds up in the interior of the energy storage cell, the rupture zone can rupture and a hot gas can flow out in a predefined direction.

The object is achieved according to the invention by the motor vehicle as claimed in the relevant independent claim.

The motor vehicle comprises in particular the following:
a protective element, described herein, according to the invention, and
an energy storage system.

The energy storage system comprised by the motor vehicle can be, for example, an electrochemical energy storage system.

The energy storage system comprised by the motor vehicle can preferably be an energy storage system, described herein, according to the invention. The energy storage system can comprise the protective element, for example such as has been described in detail herein in connection with the energy storage system according to the invention.

The motor vehicle can comprise the protective element. The protective element can be arranged or formed on at least one component of the motor vehicle that is not a component of the energy storage system. The protective element can form an underbody protective element of the motor vehicle or part of an underbody protective element of the motor vehicle.

The protective material can preferably be arranged or formed on a bottom surface of the underbody protective element that can face or faces a road on which the motor vehicle is able to travel. At least a portion of the underbody protective element can extend into a region lying between the energy storage system and the road.

The motor vehicle can comprise multiple protective elements, described herein, according to the invention. The motor vehicle can comprise, for example, a first and a second protective element.

The first protective element can be a protective element described herein that is comprised by the energy storage system. The second protective element can be the protective element described herein and arranged or formed on at least one component of the motor vehicle that is not a component of the energy storage system, for example the underbody protective element.

It is preferred for the protective element or at least one of the protective elements to shield an environment of the energy storage system against hazards that may originate from the energy storage cell or the energy storage cells, for example in the event of a thermal runaway.

It is preferred for the motor vehicle to be driven wholly or partially by means of the energy storage system, for example by means of the electrochemical energy storage system.

Preferably, a surface of the shielding element on which the protective material is arranged or formed can form an outer surface of the motor vehicle, for example a bottom outer surface of the motor vehicle that faces or can face a road covering.

The motor vehicle can comprise an energy storage system, for example an energy storage system, described herein, according to the invention.

A further surface of the shielding element can face the energy storage system.

The object is achieved according to the invention by the method as claimed in the relevant independent claim.

The method is a method for producing a protective element for an energy storage system or for a motor vehicle, wherein a protective material is arranged or formed on a surface of a shielding element, for example a wall. It is preferred for the protective material to be arranged or formed on the surface by thermal spraying.

The protective material can be arranged or formed, for example, on a surface of the wall.

Thermal spraying can be carried out in any suitable way by which a protective material provided for a specific purpose can be arranged or formed.

Thermal spraying can preferably be carried out by electric arc spraying, plasma spraying, flame spraying, high-velocity flame spraying, cold spraying or laser beam spraying.

Thermal spraying can be carried out, for example, by plasma spraying, by flame spraying or by high-velocity flame spraying.

Methods for thermal spraying have long been known and are efficient. They are used industrially on a large scale. Not least for this reason, the protective element according to the invention, the energy storage system according to the invention and the protective element according to the invention are obtainable by the method according to the invention with a low outlay. The subject matter according to the invention is efficient because the protective material can be applied in very uniform, thin layers, which are able to develop a desired protective action even in a small thickness.

Consequential damage of external applied forces and accidents is counteracted efficiently. This is because, on the one hand, the risk of a thermal runaway of energy storage cells can be lowered with the protective element in the form of an underbody element. Foreign bodies are kept away from the energy storage cells by the impact-resistant underbody element. On the other hand, in the event of a thermal runaway, resistance toward hot fluids can be increased with the protective element in the form of a wall of a housing. This also makes it possible for walls of housings to be installed closer to energy storage cells. More energy storage cells can then be accommodated in a given installation space. This increases the energy density and thus, ultimately, the range of a motor vehicle.

Features described in connection with a subject matter according to the invention can of course also form features of a different subject matter according to the invention. Subject matter according to the invention is in particular the protective element according to the invention, the energy storage system according to the invention, the motor vehicle according to the invention, and the method according to the invention.

### BRIEF DESCRIPTION OF THE DRAWINGS

Further preferred features and/or advantages of the invention are subject matter of the following description and of the representation of exemplary embodiments in the drawings, in which:

FIG. 1: shows a schematic representation of energy storage cells of an energy storage system;

FIG. 2: shows a schematic sectional representation of the energy storage cells of FIG. 1 with a protective element;

FIG. 3: shows an enlarged detail of the sectional representation of FIG. 2; and

FIG. 4: shows a motor vehicle, represented schematically, wherein the underside of the motor vehicle is facing the viewer.

Identical or functionally equivalent elements are designated by the same reference signs in all the figures.

### DETAILED DESCRIPTION OF THE DRAWINGS

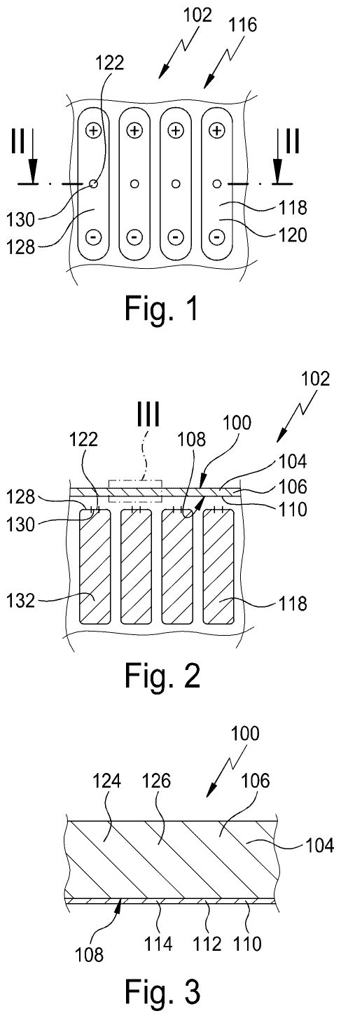

FIGS. 1 and 2 show an energy storage system 102, which comprises a protective element 100. The construction of the protective element 100 is apparent from FIG. 3.

The protective element 100 has a shielding element 104. The shielding element 104 is a wall 106. The protective element 100 also has a protective material 110 arranged or formed on a surface 108 of the shielding element 104.

The protective element 100 forms part of a housing 124, for example a cover 126, of the energy storage system 102.

The protective material 110 is formed on the surface 108 by thermal spraying. In the example shown here, the protective material 110 is a protective layer 112 consisting of a NaCrAlY alloy 114.

The protective material 110 shown here increases the hot-fluid resistance of the shielding element 104.

The energy storage system 102 is an electrochemical energy storage system 116.

The energy storage system 102 comprises energy storage cells 118. The energy storage cells 118 are electrochemical energy storage cells 120.

The surface 108 faces the energy storage cells 118. It faces rupture zones 122 formed on the energy storage cells 118.

Each cell casing 128 has a predetermined breaking point 130 at the rupture zone 122. If a growing pressure builds up in the interior 132 of the energy storage cell 118, for example as a result of a thermal runaway, the rupture zone can rupture and a hot fluid can flow out in a predefined direction, wherein the hot fluid strikes the protective material 110 that increases the hot-fluid resistance of the shielding element 104.

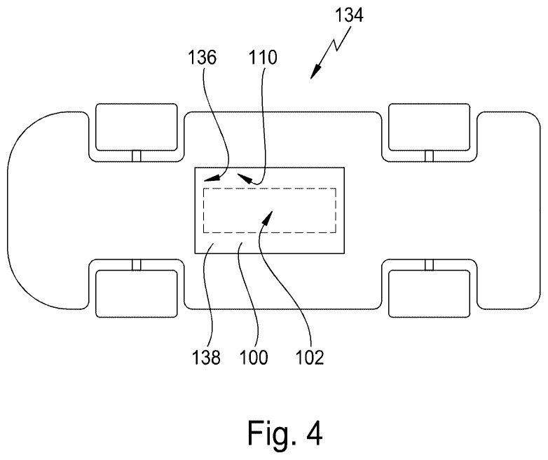

FIG. 4 shows a motor vehicle 134, wherein an underside of the motor vehicle is oriented toward the viewer. The motor vehicle 134 comprises a protective element 100, and an energy storage system 102 concealed by the protective element 100 and therefore shown by a broken line.

The protective element 100 comprises a shielding element 104. A surface of the shielding element 104 that faces the viewer and on which the protective material 110 is formed is covered completely by the protective material 110. This surface of the shielding element, together with the protective material 110 formed thereon, forms an outer surface 136 of the motor vehicle 134. The outer surface 136 faces the road covering during travel.

The protective element 100 is an underbody protective element 138 of the motor vehicle 134.

### LIST OF REFERENCE SIGNS

100 protective element
102 energy storage system
104 shielding element
106 wall
108 surface
110 protective material
112 protective layer
114 NiCrAlY alloy
116 electrochemical energy storage system
118 energy storage cell
120 electrochemical energy storage cell
122 rupture zone
124 housing
126 cover
128 cell casing
130 predetermined breaking point
132 interior
134 motor vehicle
136 outer surface
138 underbody protective element

1. A protective element, for an energy storage system or for a motor vehicle, the protective element comprising:
a shielding element or a wall, and
a protective material arranged or formed on a surface of the shielding element.

2. The protective element as claimed in claim 1, wherein
the protective material is arranged or formed on the surface by thermal spraying, or
by plasma spraying, or by flame spraying or by high-velocity flame spraying.

3. The protective element as claimed in claim 1, wherein
the protective material
increases the hot-fluid resistance of the shielding element; and/or
increases the media resistance of the shielding element; and/or
increases the corrosion resistance of the shielding element; and/or
impedes an electrical breakdown to the shielding element; and/or
increases the impact resistance of the shielding element.

4. The protective element as claimed in claim 1, wherein
the protective material comprises at least one high-temperature-stable alloy according to formula (I) 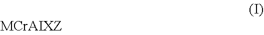
wherein
M represents at least one of the elements Ni, Co, Fe,
X represents at least one optional chemical element selected from Y, Si and/or Ti, and
Z represents at least one optional further chemical element.

5. The protective element as claimed in claim 1, wherein
the protective material comprises a NiCrAlY alloy, a cobalt-based alloy, a FeCrAl alloy, a nickel-based superalloy, a cobalt-based superalloy, tungsten, tungsten-chromium, tantalum, molybdenum, niobium, a titanium aluminide, a ceramic, aluminum oxide, zirconium oxide, titanium oxide, magnesium oxide, chromium oxide, yttrium oxide, tungsten carbide, a tungsten carbide-cobalt alloy or WC—Co 12, silicon carbide, silicon nitride, titanium carbide, tantalum carbide and/or hafnium carbide.

6. The energy storage system, for driving said motor vehicle, wherein the energy storage system comprising:
said protective element as claimed in claim 1, and
an energy storage cell, wherein
a surface of the shielding element on which the protective material is arranged or formed faces the energy storage cell.

7. A motor vehicle, wherein the motor vehicle comprising:
said protective element as claimed in claim 1, and
said energy storage system.

8. The motor vehicle as claimed in claim 7, wherein
a surface of the shielding element on which the protective material is arranged or formed forms an outer surface of the motor vehicle or a bottom outer surface of the motor vehicle that faces or can face a road covering.

9. The motor vehicle as claimed in claim 8, wherein
a second surface of the shielding element faces the energy storage system.

10. A method for producing a protective element for an energy storage system or for a motor vehicle, wherein
a protective material is arranged or formed on a surface of a shielding element or a wall, and
the protective material is arranged or formed on the surface by thermal spraying, or by plasma spraying, or by flame spraying or by high-velocity flame spraying.
